(19) United States
(12) Patent Application Publication
(10) Pub. No.: US 2026/0067992 A1
(43) Pub. Date: Mar. 5, 2026

(54) SYSTEMS AND METHODS FOR REFINING USER EQUIPMENT LOCATION FOR WIRELESS EMERGENCY LOCATION-BASED CALL ROUTING

(71) Applicant: T-MOBILE INNOVATIONS LLC, Overland Park, KS (US)

(72) Inventor: Wei-Ming LAN, Morrisville, NC (US)

(21) Appl. No.: 18/822,944

(22) Filed: Sep. 3, 2024

(51) Int. Cl. H04W 76/50; H04W 64/00

(52) U.S. Cl. CPC H04W 76/50; H04W 64/00

(57) ABSTRACT

Systems and methods are provided for refining user equipment (UE) location for wireless emergency location-based call routing. When an emergency call is initiated, a location comprising a horizontal uncertainty and a confidence level is generated. The horizontal uncertainty is compared to an uncertainty threshold. If the horizontal uncertainty is equal to or below the uncertainty threshold, the location may be communicated to the gateway and communication between the UE and a public safety answer point (PSAP) is initiated. If the horizontal uncertainty is above the uncertainty threshold, a second location comprising a second horizontal uncertainty and a second confidence level may be generated. In aspects, the location or the second location is generated utilizing one or more of: global navigation satellite system, device-based hybrid, Wi-Fi Location provider, Network-Location provider.

### SUMMARY

Embodiments of the technology described herein are directed to, among other things, systems and methods for refining user equipment (UE) location for wireless emergency location-based call routing. More particularly, when a user makes an emergency call from a UE, a location engine of the UE generates a location along with a horizontal uncertainty and a confidence level associated with the location. The horizontal uncertainty (i.e., accuracy) is used to determine the quality of the location for a fixed confidence level. The horizontal uncertainty can change from time to time even at the same location due to many factors such as a number of global positioning system (GPS) satellites visible at the time the location is generated, a number of detectable wireless access points, etc. The uncertainty is compared to an uncertainty threshold. If the uncertainty is equal to or below the threshold, the location is communicated to a gateway mobile location center (i.e., gateway) and communication between the UE and a public safety answer point (PSAP) can be initiated. If the uncertainty is above the threshold, the UE can generate a second location using the same or a different location engine supported by the UE until a qualified location becomes available or until a safeguard timer expires. In this way, the UE can generate an accurate location and communicate with the PSAP as soon as possible, while ensuring a transfer to a different PSAP is not needed.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present technology are described in detail herein with reference to the attached figures, which are intended to be exemplary and non-limiting, wherein:

FIG. 1 illustrates a diagram of an exemplary network environment in which implementations of the present disclosure may be employed;

FIG. 2 illustrates a diagram of a location engine, in accordance with aspects herein;

FIG. 3 is a flow diagram of an example method for refining user equipment (UE) location for wireless emergency location-based call routing, in accordance with some aspects of the technology described herein; and

FIG. 4 depicts an example computing environment suitable for use in implementation of the present disclosure.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Wireless Technology
4G Fourth-Generation Cellular Communication System
5G Fifth-Generation Cellular Communication System
6G Sixth-Generation Cellular Communication System
AI Artificial Intelligence
CD-ROM Compact Disk Read Only Memory
CDMA Code Division Multiple Access
eNodeB Evolved Node B
GIS Geographic/Geographical/Geospatial Information System
gNodeB Next Generation Node B
GPRS General Packet Radio Service
GSM Global System for Mobile communications
iDEN Integrated Digital Enhanced Network
DVD Digital Versatile Discs
EEPROM Electrically Erasable Programmable Read Only Memory
LED Light Emitting Diode
LTE Long Term Evolution
MIMO Multiple Input Multiple Output
MD Mobile Device
ML Machine Learning
PC Personal Computer
PCS Personal Communications Service
PDA Personal Digital Assistant
PDSCH Physical Downlink Shared Channel
PHICH Physical Hybrid ARQ Indicator Channel
PUCCH Physical Uplink Control Channel
PUSCH Physical Uplink Shared Channel
RAM Random Access Memory
RET Remote Electrical Tilt
RF Radio-Frequency
RFI Radio-Frequency Interference
R/N Relay Node
RNR Reverse Noise Rise
ROM Read Only Memory
RSRP Reference Signal Receive Power
RSRQ Reference Signal Receive Quality
RSSI Received Signal Strength Indicator
SINR Transmission-to-Interference-Plus-Noise Ratio
SNR Transmission-to-noise ratio
SON Self-Organizing Networks
TDMA Time Division Multiple Access
TXRU Transceiver (or Transceiver Unit)
UE User Equipment
UMTS Universal Mobile Telecommunications Systems
WCD Wireless Communication Device (interchangeable with UE)

Further, various technical terms are used throughout this description. An illustrative resource that fleshes out various aspects of these terms can be found in Newton's Telecom Dictionary, 32^{nd} Edition (2022). These definitions are intended to provide a clearer understanding of the ideas disclosed herein but are not intended to limit the scope of the present invention. The definitions and terms should be interpreted broadly and liberally to the extent allowed by the meaning of the words offered in the above-cited reference.

Embodiments of the technology may take the form of, among other things: a method, system, or set of instructions embodied on one or more computer-readable media. Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include but are not limited to information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an eNodeB). In this regard, typically only one active uplink connection can occur per frequency. The base station may include one or more sectors served by individual transmitting/receiving components associated with the base station (e.g., antenna arrays controlled by an eNodeB). These transmitting/receiving components together form a multi-sector broadcast arc for communication with mobile handsets linked to the base station.

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service.

The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network.

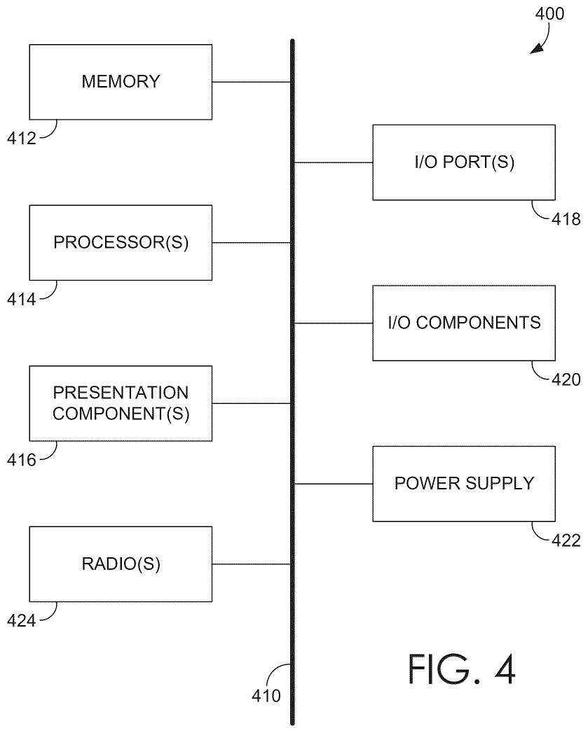

For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point. A UE may be, in an embodiment, similar to device 400 described herein with respect to FIG. 4.

Emergency 911 calls are routed based on UE location to increase the chance of the call reaching correct PSAP. This ensures emergency calls are not delayed due to being transferred to another PSAP. As such, a UE needs to self-locate and deliver the location to the Gateway Mobile Location Centre (GMLC) or gateway before a call can be routed to the PSAP. For clarity, the gateway contains functionality required to support location-based service (LBS). Currently, the objective of mobile network providers to reach the PSAP in the shortest time as possible without considering if the call reaches the correct or appropriate PSAP.

Traditionally, emergency calls were routed based on cell site location. The coverage of cell sites located on or near the boundary of two or more PSAP jurisdictions could cover two or more PSAPs at the same time. This resulted in some emergency calls being routed to the wrong PSAP. The calls have to be rerouted to the appropriate PSAP which caused additional delays.

Modern UEs are equipped with many location technologies such as global navigation satellite system (GNSS), device-based hybrid (DBH), enhanced cell ID (ECID), angle-of-arrival/round trip time (AOA/RTT). When a user makes an emergency call from a UE, a location engine of the UE generates a location along with a horizontal uncertainty and a confidence level associated with the location. The horizontal uncertainty (i.e., accuracy) is used to determine the quality of the location for a fixed confidence level. The horizontal uncertainty can change from time to time even at the same location due to many factors such as a number of global positioning system (GPS) satellites visible at the time the location is generated, a number of detectable wireless access points, etc.

The present disclosure is directed to systems, methods, and computer readable media that systems and methods for refining user equipment (UE) location for wireless emergency call routing. More particularly, when an emergency call is initiated, a location comprising a horizontal uncertainty and a confidence level is generated. The horizontal uncertainty is compared to an uncertainty threshold. If the horizontal uncertainty is equal to or below the uncertainty threshold, the location may be communicated to the gateway and communication between the UE and a public safety answer point (PSAP) is initiated. If the horizontal uncertainty is above the uncertainty threshold, a second location comprising a second horizontal uncertainty and a second confidence level may be generated. In aspects, the location or the second location is generated utilizing one or more of: global navigation satellite system, device-based hybrid, Wi-Fi Location provider, Network-Location provider. In this way, the UE can generate an accurate location and communicate with the PSAP as soon as possible, while ensuring a transfer to a different PSAP is not needed.

In a first aspect of the present invention, computer-readable media is provided, the computer-readable media having computer-executable instructions embodied thereon that, when executed, perform a method for refining user equipment (UE) location for wireless emergency location-based call routing. The method includes initiating, at the UE, an emergency call. The method also includes generating, by a location engine of the UE, a location comprising a horizontal uncertainty and a confidence level. The method further includes comparing the horizontal uncertainty to an uncertainty threshold. Based on the comparing the horizontal uncertainty to an uncertainty threshold.

In a second aspect of the present invention, a method for refining user equipment (UE) location for wireless emergency location-based call routing. The method includes initiating, at the UE, an emergency call. The method also includes generating, by a location engine of the UE, a location comprising a horizontal uncertainty and a confidence level. The method further includes comparing the horizontal uncertainty to an uncertainty threshold. Based on the comparing the horizontal uncertainty to an uncertainty threshold.

In a third aspect of the present invention, a system for refining user equipment (UE) location for wireless emergency location-based call routing is provided. The system comprises a node configured to wirelessly communicate with one or more UEs. The system also comprises a UE of the one or more UEs that: initiates an emergency call; generates, by a location engine of the UE, a location comprising a horizontal uncertainty and a confidence level; compares the horizontal uncertainty to an uncertainty threshold; and based on the comparing, determines if the location can be communicated to a gateway.

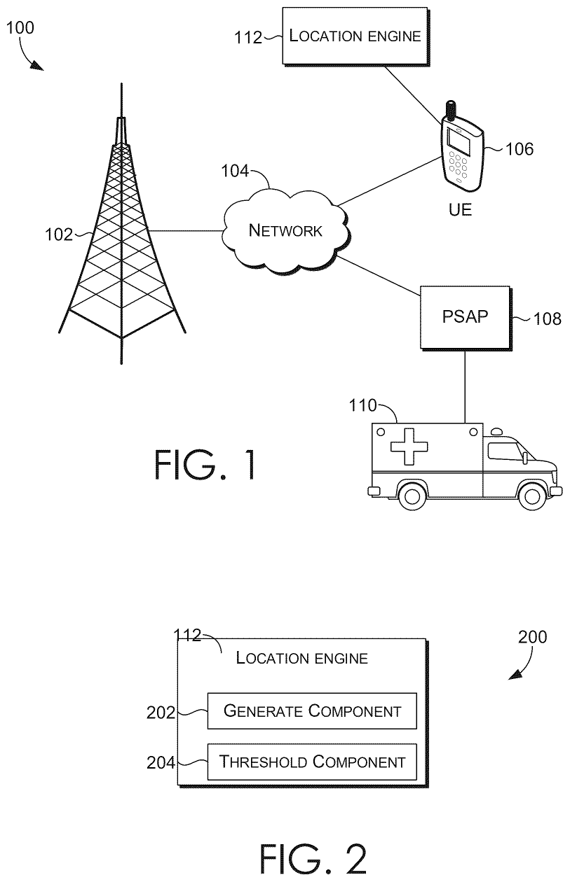

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

A network cell may comprise a base station to facilitate wireless communication between a communications device within the network cell, such as communications device 400 described with respect to FIG. 4, and a network. As shown in FIG. 1, a communications device may be a UE 106. In the network environment 100, UE 106 may communicate with other devices, such as mobile devices, servers, etc. The UE 106 may take on a variety of forms, such as a personal computer, a laptop computer, a tablet, a netbook, a mobile phone, a Smart phone, a personal digital assistant, or any other device capable of communicating with other devices. For example, the UE 106 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 106 comprises a wireless or mobile device with which a wireless telecommunication network(s) can be utilized for communication (e.g., voice and/or data communication). In this regard, the UE 106 can be any mobile computing device that communicates by way of, for example, a 5G network.

The UE 106 may utilize network 104 to communicate with other computing devices (e.g., mobile device(s), a server(s), a personal computer(s), etc.). In embodiments, network 104 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 104 may include multiple networks, as well as being a network of networks, but is shown in more simple form so as to not obscure other aspects of the present disclosure. Network 104 may be part of a telecommunications network that connects subscribers to their immediate service provider. In embodiments, network 104 is associated with a telecommunications provider that provides services to user devices, such as UE 106. For example, network 104 may provide voice services to user devices or corresponding users that are registered or subscribed to utilize the services provided by a telecommunications provider. It is contemplated network 104 can be any communication network providing voice and/or data service(s), such as, for example, a 1x circuit voice, a 3G network (e.g., CDMA, CDMA1000, WCDMA, GSM, UMTS), a 4G network (WiMAX, LTE, HSDPA), or the like.

The network environment 100 may include a database (not shown). The database may be similar to the memory component 412 in FIG. 4 and can be any type of medium that is capable of storing information. The database can be any collection of records (e.g., cached location of UE). In one embodiment, the database includes a set of embodied computer-executable instructions that, when executed, facilitate various aspects disclosed herein. These embodied instructions will variously be referred to as “instructions” or an “application” for short.

As previously mentioned, the UE 106 may communicate with other devices by using a base station, such as base station 102. In embodiments, base station 102 is a wireless communications station that is installed at a fixed location, such as at a radio tower, as illustrated in FIG. 1. The radio tower may be a tall structure designed to support one or more antennas for telecommunications and/or broadcasting. In other embodiments, base station 102 is a mobile base station. The base station 102 may be an MMU and include gNodeB for mMIMO/5G communications via network 104. In this way, the base station 102 can facilitate wireless communication between UE 106 and network 104.

As stated, the base station 102 may include a radio (not shown) or a remote radio head (RRH) that generally communicates with one or more antennas associated with the base station 102. In this regard, the radio is used to transmit signals or data to an antenna associated with the base station 102 and receive signals or data from the antenna. Communications between the radio and the antenna can occur using any number of physical paths. A physical path, as used herein, refers to a path used for transmitting signals or data. As such, a physical path may be referred to as a radio frequency (RF) path, a coaxial cable path, cable path, or the like.

The antenna is used for telecommunications. Generally, the antenna may be an electrical device that converts electric power into radio waves and converts radio waves into electric power. The antenna is typically positioned at or near the top of the radio tower as illustrated in FIG. 1. Such an installation location, however, is not intended to limit the scope of embodiments of the present invention. The radio associated with the base station 102 may include at least one transceiver configured to receive and transmit signals or data.

In practice, a user of a UE 106 may need emergency services. The user places a call to emergency services (e.g., 911) and the base station 102 facilitates wireless communication between UE 106 and PSAP 108 via the network. However, in order for the gateway corresponding to the base station 102 to route the emergency call from the UE 106 to the appropriate PSAP 108, an accurate location must be communicated to the gateway. Once the location is communicated to the gateway, the UE 106 is enabled to communicate with the PSAP 108.

Continuing, the network environment 100 may further include a location engine 112. The location engine 112 may be configured to, among other things, acquire the location of the UE 106 and/or compare an uncertainty corresponding to the location to an uncertainty threshold. Though location engine 112 is illustrated as a component of UE 106 in FIG. 1, it may be a standalone device (e.g., a server having one or more processors), a service provided via the 5G network 104, a component of the base station 102, or may be remotely located.

Referring now to FIG. 2, the location engine 112 may include, among other things, generate component 202 and threshold component 204. The location engine 112 may receive, among other things, data from user devices, such as UE 106, or PSAP 108 within a network cell associated with a particular base station 102. Additionally or alternatively, the location engine 112 may receive, among other things, data from base station 102, such as data from a gNodeB or eNodeB or from a plurality of base stations.

Generate component 202 generally generates a location of UE. Generate component 202 also generates a horizontal uncertainty and confidence level associated with each location. As mentioned, the horizontal uncertainty can change from time to time even at the same location due to many factors such as a number of GPS satellites visible at the time the location is generated, a number of detectable wireless access points, etc. Generate component 202 may utilize one or more of: global navigation satellite system, device-based hybrid, Wi-Fi Location provider, Network-Location provider to generate the location (or subsequent locations).

Compare component 204 generally compares the horizontal uncertainty to an uncertainty threshold. If the horizontal uncertainty is equal to or below the uncertainty threshold, the location may be communicated to the gateway and communication between the UE and a PSAP is initiated. If the horizontal uncertainty is above the uncertainty threshold, a second location comprising a second horizontal uncertainty and a second confidence level may be generated.

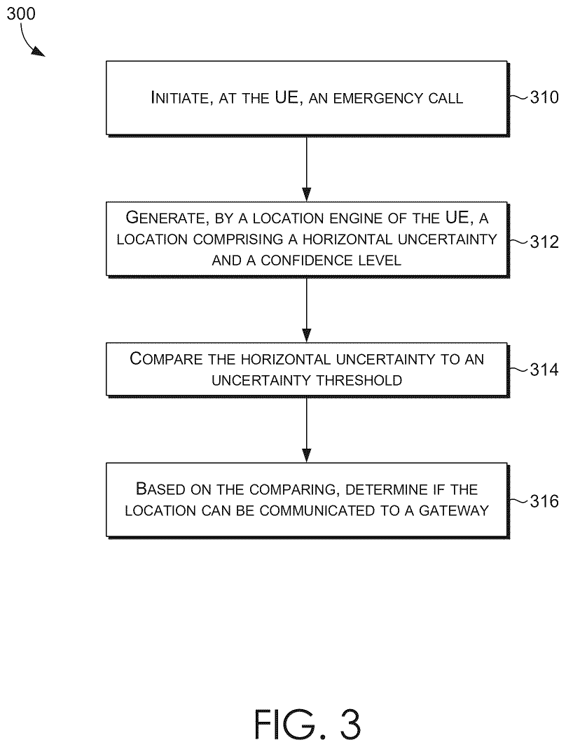

Referring to FIG. 3, a flow diagram is provided depicting a method for refining user equipment (UE) location for wireless emergency location-based call routing, according to aspects of the technology described herein. Method 300 may be performed by any computing device (such as computing device described with respect to FIG. 4) with access to a movement engine (such as the one described with respect to FIGS. 1 and 2) or by one or more components of the network environment described with respect to FIG. 1 (such as UE 106, base station 102, or location engine 112). Initially, at step 310, a UE initiates an emergency call.

At step 312, a location engine of the UE generates a location comprising a horizontal uncertainty and a confidence level. In aspects, the location engine utilizes one or more of: global navigation satellite system, device-based hybrid, Wi-Fi Location provider, Network-Location provider to determine the location.

At step 314, the horizontal uncertainty is compared to an uncertainty threshold. Based on the comparing, it is determined if the location can be communicated to a gateway. For example, if the horizontal uncertainty is equal to or below the uncertainty threshold, the location is communicated to the gateway and communication is initiated between the UE and the PSAP. On the other hand, if the horizontal uncertainty is above the uncertainty threshold, a second location comprising a second horizontal uncertainty and a second confidence level is generated by the location engine of the UE or a second location engine of the UE. In aspects, the second location engine utilizes one or more of: global navigation satellite system, device-based hybrid, Wi-Fi Location provider, Network-Location provider to determine the second location. The process may continue until the horizontal uncertainty is equal to or below the uncertainty threshold or a safeguard timer has expired (at which point the cell site location a location using another technology or method may be communicated to the gateway).

Embodiments of the technology described herein may be embodied as, among other things, a method, a system, or a computer-program product. Accordingly, the embodiments may take the form of a hardware embodiment, or an embodiment combining software and hardware. The present technology may take the form of a computer-program product that includes computer-useable instructions embodied on one or more computer-readable media. The present technology may further be implemented as hard-coded into the mechanical design of network components and/or may be built into a broadcast cell or central server.

Computer-readable media includes both volatile and non-volatile, removable and non-removable media, and contemplate media readable by a database, a switch, and/or various other network devices. Network switches, routers, and related components are conventional in nature, as are methods of communicating with the same. By way of example, and not limitation, computer-readable media may comprise computer storage media and/or non-transitory communications media.

Computer storage media, or machine-readable media, may include media implemented in any method or technology for storing information. Examples of stored information include computer-useable instructions, data structures, program modules, and other data representations. Computer storage media may include, but are not limited to, RAM, ROM, EEPROM, flash memory or other memory technology, CD-ROM, digital versatile discs (DVD), holographic media or other optical disc storage, magnetic cassettes, magnetic tape, magnetic disk storage, and/or other magnetic storage devices. These memory components may store data momentarily, temporarily, and/or permanently, and are not limited to the examples provided.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Referring to FIG. 4, a block diagram of an exemplary computing device 400 suitable for use in implementations of the technology described herein is provided. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated. It should be noted that although some components in FIG. 4 are shown in the singular, they may be plural. For example, the computing device 400 might include multiple processors or multiple radios. In aspects, the computing device 400 may be a UE/WCD, or other user device, capable of two-way wireless communications with an access point. Some non-limiting examples of the computing device 400 include a cell phone, tablet, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

As shown in FIG. 4, computing device 400 includes a bus 410 that directly or indirectly couples various components together, including memory 412, processor(s) 414, presentation component(s) 416 (if applicable), radio(s) 424, input/output (I/O) port(s) 418, input/output (I/O) component(s) 420, and power supply(s) 422. Although the components of FIG. 4 are shown with lines for the sake of clarity, in reality, delineating various components is not so clear, and metaphorically, the lines would more accurately be grey and fuzzy. For example, one may consider a presentation component such as a display device to be one of I/O components 420. Also, processors, such as one or more processors 414, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of the present disclosure and refer to “computer” or “computing device.”

Memory 412 may take the form of memory components described herein. Thus, further elaboration will not be provided here, but it should be noted that memory 412 may include any type of tangible medium that is capable of storing information, such as a database. A database may be any collection of records, data, and/or information. In one embodiment, memory 412 may include a set of embodied computer-executable instructions that, when executed, facilitate various functions or elements disclosed herein. These embodied instructions will variously be referred to as “instructions” or an “application” for short.

Processor 414 may actually be multiple processors that receive instructions and process them accordingly. Presentation component 416 may include a display, a speaker, and/or other components that may present information (e.g., a display, a screen, a lamp (LED), a graphical user interface (GUI), and/or even lighted keyboards) through visual, auditory, and/or other tactile cues.

Radio 424 represents a radio that facilitates communication with a wireless telecommunications network. Illustrative wireless telecommunications technologies include CDMA, GPRS, TDMA, GSM, and the like. Radio 424 might additionally or alternatively facilitate other types of wireless communications including Wi-Fi, WiMAX, LTE, 3G, 4G, LTE, mMIMO/5G, NR, VoLTE, or other VoIP communications. As can be appreciated, in various embodiments, radio 424 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

The input/output (I/O) ports 418 may take a variety of forms. Exemplary I/O ports may include a USB jack, a stereo jack, an infrared port, a firewire port, other proprietary communications ports, and the like. Input/output (I/O) components 420 may comprise keyboards, microphones, speakers, touchscreens, and/or any other item usable to directly or indirectly input data into the computing device 400.

Power supply 422 may include batteries, fuel cells, and/or any other component that may act as a power source to supply power to the computing device 400 or to other network components, including through one or more electrical connections or couplings. Power supply 422 may be configured to selectively supply power to different components independently and/or concurrently.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

What is claimed is:

1. One or more computer-readable media having computer-executable instructions embodied thereon that, when executed, perform a method for refining user equipment (UE) location for wireless emergency location-based call routing, the method comprising:
initiating, at the UE, an emergency call;
generating, by a location engine of the UE, a location comprising a horizontal uncertainty and a confidence level;
comparing the horizontal uncertainty to an uncertainty threshold;
based on the comparing, determining if the location can be communicated to a gateway.

2. The media of claim 1, further comprising, determining the horizontal uncertainty is equal to or below the uncertainty threshold.

3. The media of claim 2, further comprising communicating the location to the gateway.

4. The media of claim 3, further comprising initiating communication between the UE and a public safety answer point (PSAP).

5. The media of claim 1, further comprising, determining the horizontal uncertainty is above the uncertainty threshold.

6. The media of claim 5, further comprising generating, by the location engine of the UE or a second location engine of the UE, a second location comprising a second horizontal uncertainty and a second confidence level.

7. The media of claim 6, wherein the location engine and the second location engine utilize one or more of: global navigation satellite system, device-based hybrid, Wi-Fi Location provider, Network-Location provider to determine the location or the second location.

8. A method for refining user equipment (UE) location for wireless emergency location-based call routing, the method comprising:
initiating, at the UE, an emergency call;
generating, by a location engine of the UE, a location comprising a horizontal uncertainty and a confidence level;
comparing the horizontal uncertainty to an uncertainty threshold;
based on the comparing, determining if the location can be communicated to a gateway.

9. The method of claim 8, further comprising, determining the horizontal uncertainty is equal to or below the uncertainty threshold.

10. The method of claim 9, further comprising communicating the location to the gateway.

11. The method of claim 10, further comprising initiating communication between the UE and a public safety answer point (PSAP).

12. The method of claim 8, further comprising, determining the horizontal uncertainty is above the uncertainty threshold.

13. The media of claim 12, further comprising generating, by the location engine of the UE or a second location engine of the UE, a second location comprising a second horizontal uncertainty and a second confidence level.

14. The method of claim 13, wherein the location engine and the second location engine utilize one or more of: global navigation satellite system, device-based hybrid, Wi-Fi Location provider, Network-Location provider to determine the location or the second location

15. A system for refining user equipment (UE) location for wireless emergency location-based call routing, the system comprising:
a node configured to wirelessly communicate with one or more UEs; and
a UE of the one or more UEs that:
(1) initiates, at the UE, an emergency call;
(2) generates, by a location engine of the UE, a location comprising a horizontal uncertainty and a confidence level;
(3) compares the horizontal uncertainty to an uncertainty threshold;
(4) based on the comparing, determines if the location can be communicated to a gateway.

16. The system of claim 15, further comprising, determining the horizontal uncertainty is equal to or below the uncertainty threshold.

17. The system of claim 16, further comprising communicating the location to the gateway.

18. The system of claim 17, further comprising initiating communication between the UE and a public safety answer point (PSAP).

19. The system of claim 15, further comprising, determining the horizontal uncertainty is above the uncertainty threshold.

20. The system of claim 19, further comprising generating, by the location engine of the UE or a second location engine of the UE, a second location comprising a second horizontal uncertainty and a second confidence level, wherein the location engine and the second location engine utilize one or more of: global navigation satellite system, device-based hybrid, Wi-Fi Location provider, Network-Location provider to determine the location or the second location
